(19) United States
(12) Patent Application Publication
(10) Pub. No.: US 2026/0367467 A1
(43) Pub. Date: Nov. 19, 2026

(54) HOME APPLIANCE, ELECTROPHORETIC DISPLAY PANEL, AND METHOD FOR MANUFACTURING ELECTROPHORETIC DISPLAY PANEL

(71) Applicant: SAMSUNG ELECTRONICS CO., LTD., Suwon-si (KR)

(72) Inventors: Kyunghwan LEE, Suwon-si (KR); Youngdeog KOH, Suwon-si (KR); Hoon WEE, Suwon-si (KR); Myunghyuk IM, Suwon-si (KR)

(73) Assignee: SAMSUNG ELECTRONICS CO., LTD., Suwon-si (KR)

(21) Appl. No.: 19/446,295

(22) Filed: Jan. 12, 2026

Related U.S. Application Data
(63) Continuation of application No. PCT/KR2024/008679, filed on Jun. 24, 2024.

(30) Foreign Application Priority Data
Aug. 4, 2023 (KR) 10-2023-0102472

(51) Int. Cl. G02F 1/1679; G02F 1/167

(52) U.S. Cl. CPC G02F 1/1679; G02F 1/167

(57) ABSTRACT

An electrophoretic display panel according to an embodiment of the present disclosure includes a plurality of electrophoretic films disposed adjacent to each other, an upper protective sheet arranged to cover an upper portion of the plurality of electrophoretic films, a lower protective sheet arranged to cover a lower portion of the plurality of electrophoretic films, and a sealing portion configured to seal an outer periphery of the plurality of electrophoretic films, an outer periphery of the upper protective sheet, and an outer periphery of the lower protective sheet.

### CROSS-REFERENCE TO RELATED APPLICATION

This application is a continuation application, under 35 U.S.C. § 111(a), of international application No. PCT/KR2024/008679, filed Jun. 24, 2024, which claims priority under 35 U.S. C. § 119 to Korean Patent Application No. 10-2023-0102472, filed Aug. 4, 2023, the disclosures of which are incorporated herein by reference in their entireties.

### TECHNICAL FIELD

The disclosure relates to a home appliance, an electrophoretic display panel, and a method for manufacturing thereof.

### BACKGROUND ART

Home appliances are devices that are primarily provided in a user's home to assist with household chores, and include refrigerators, air conditioners, air purifiers, vacuum cleaners, cooking appliances, dishwashers, clothes care appliances, washing machines, and the like.

The most visible part of a home appliance is usually the panel that forms the appearance of the home appliance. Therefore, users may change the appearance design of the home appliance by changing the exterior panel of the home appliance according to their preferences. However, when attempting to change the appearance design of a home appliance by replacing the exterior panel, it is necessary to obtain a separate exterior panel and reinstall the exterior panel, which may cause losses in terms of cost and time.

In recent years, home appliances using electrophoretic displays have been developed that may change the design without replacing the exterior panel. However, electrophoretic displays may only display two colors, making it difficult to implement a variety of colors and design patterns.

### DISCLOSURE

### Technical Problem

An embodiment of the present disclosure provides a home appliance, an electrophoretic display panel and a method of manufacturing the same, which are capable of implementing various colors and design patterns.

Technical tasks to be achieved in this document are not limited to the technical tasks mentioned above, and other technical tasks not mentioned will be clearly understood by those skilled in the art from the description below.

### Technical Solution

An electrophoretic display panel according to an embodiment of the present disclosure includes a plurality of electrophoretic films disposed adjacent to each other, an upper protective sheet arranged to cover an upper portion of the plurality of electrophoretic films, a lower protective sheet arranged to cover a lower portion of the plurality of electrophoretic films, and a sealing portion configured to seal an outer periphery of the plurality of electrophoretic films, an outer periphery of the upper protective sheet, and an outer periphery of the lower protective sheet.

A home appliance according to an embodiment of the present disclosure includes a main body and an electrophoretic display panel configured to display operation and manipulation information of the main body, wherein the electrophoretic display panel includes a plurality of neighboring electrophoretic films, an upper protective sheet disposed to cover an upper portion of the plurality of electrophoretic films, a lower protective sheet disposed to cover a lower portion of the plurality of electrophoretic films, and a sealing portion configured to seal an edge of the plurality of electrophoretic films, an edge of the upper protective sheet, and an edge of the lower protective sheet.

A method of manufacturing an electrophoretic display panel according to an embodiment of the present disclosure includes preparing a electrophoretic film and a protective sheet, cutting the electrophoretic film into plurality of electrophoretic films and cutting the protective sheet into an upper protective sheet and a lower protective sheet, arranging the plurality of electrophoretic films adjacent to each other, bonding the upper protective sheet on an upper portion of a plurality of neighboring electrophoretic films among the plurality of electrophoretic films, the upper protective sheet cut to a size to cover the plurality of electrophoretic films, and bonding the lower protective sheet on a lower portion of the plurality of neighboring electrophoretic films, the lower protective sheet cut to a size to cover the plurality of electrophoretic films.

### Advantageous Effects

According to various embodiments of the present disclosure, various colors and design patterns can be implemented in a single electrophoretic display panel.

According to various embodiments of the present disclosure, by performing air bubble removal after bonding the protective substrate and the electrophoretic film, malfunctions of the electrophoretic display panel due to residual air bubbles may be prevented, thereby improving reliability.

According to various embodiments of the present disclosure, the printed portion can be provided at the boundary between the plurality of electrophoretic films, thereby improving the exterior quality of the home appliance.

The effects to be obtained from the present disclosure are not limited to those mentioned above, and other effects not mentioned will be apparent to a person skilled in the art to which the present disclosure belongs from the following description.

### DESCRIPTION OF DRAWINGS

FIG. 1 illustrates a robot cleaner according to an embodiment of the present disclosure.

FIG. 2 schematically illustrates a cross-section of an electrophoretic display panel according to an embodiment of the present disclosure.

FIG. 3 schematically illustrates a cross-section of an electrophoretic film according to an embodiment of the present disclosure.

FIG. 4 schematically illustrates a cross-section of the electrophoretic display panel according to an embodiment of the present disclosure.

FIG. 5 is a plan view of the electrophoretic display panel of FIG. 4 according to an embodiment of the present disclosure.

FIG. 6 schematically illustrates a cross-section of the electrophoretic display panel according to an embodiment of the present disclosure.

FIG. 7 is a block diagram illustrating some configurations of a robot cleaner, which is a type of home appliance, according to an embodiment of the present disclosure.

FIG. 8 illustrates a color change of the electrophoretic display panel of the robot cleaner, which is a type of home appliance, according to an embodiment of the present disclosure.

FIG. 9 is a flowchart illustrating a method of manufacturing an electrophoretic display panel according to an embodiment of the present disclosure.

FIG. 10 is a process diagram illustrating a method of manufacturing the electrophoretic display panel according to an embodiment of the present disclosure.

FIG. 11 is a flowchart illustrating a method for manufacturing an electrophoretic display panel according to an embodiment of the present disclosure.

FIG. 12 is a process diagram illustrating a method for manufacturing the electrophoretic display panel according to an embodiment of the present disclosure.

FIG. 13 is a flowchart illustrating a method of manufacturing an electrophoretic display panel according to an embodiment of the present disclosure.

FIG. 14 is a flowchart illustrating a method of manufacturing the electrophoretic display panel according to an embodiment of the present disclosure.

### MODES OF THE INVENTION

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

Hereinafter, various embodiments of the disclosure will be described in detail with reference to the accompanying drawings.

A home appliance according to an embodiment of the present disclosure may have an electrophoretic display panel (EPD) attached to its exterior surface, allowing the design or color of the exterior to be changed based on user input or operating conditions.

A home appliance according to an embodiment of the present disclosure may be at least one of various types of home appliances. For example, the home appliance may include at least one of a refrigerator, a dishwasher, an electric range, an electric oven, an air conditioner, a clothes care appliance, a washing machine, a dryer, a microwave oven, a cleaning robot, a vacuum cleaner, or a television, but is not limited thereto. Furthermore, the aforementioned home appliances are merely examples, and in addition to the aforementioned home appliances, other home appliances, user devices, or devices that may be connected to a server to perform the operations described herein may be included in the home appliances according to an embodiment.

The following will be describe a robot cleaner (also referred to as a robot vacuum cleaner), which is a type of home appliance.

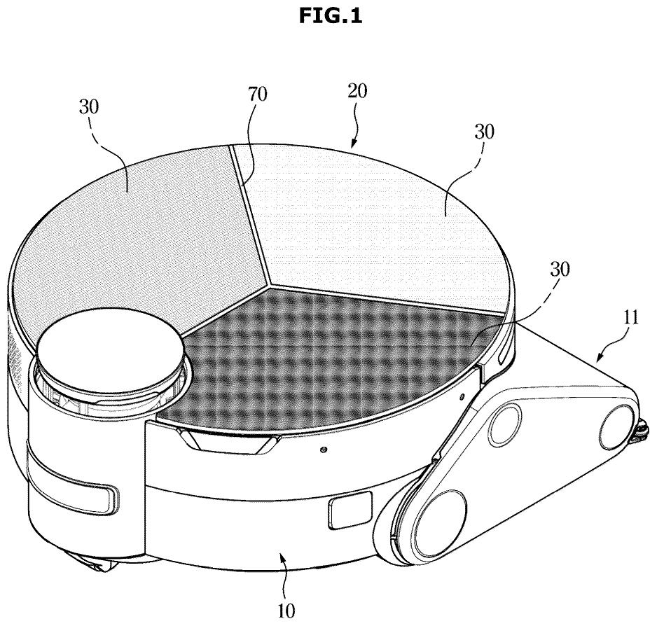

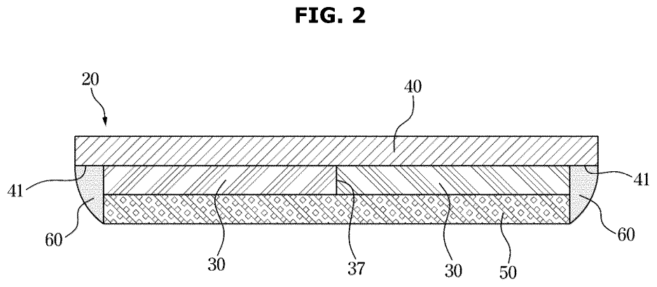

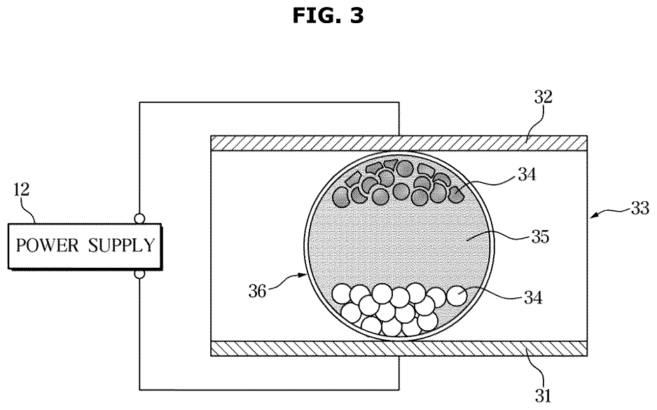

FIG. 1 illustrates a robot cleaner according to an embodiment of the present disclosure, FIG. 2 schematically illustrates a cross-section of an electrophoretic display panel according to an embodiment of the present disclosure, and FIG. 3 schematically illustrates a cross-section of an electrophoretic film according to an embodiment of the present disclosure.

Referring to FIGS. 1 to 3, a robot cleaner 1 according to an embodiment of the present disclosure may be a device for cleaning dirt or the like accumulated on a floor while traveling in a cleaning area without user operation. The robot cleaner 1 may control a drive device to thoroughly clean the cleaning area and control a cleaning device to efficiently remove dirt or the like.

The robot cleaner 1 may include a main body 10, an electrophoretic display panel 20 attached to one surface of the main body 10, and a driver unit 11 for moving the main body 10.

The main body 10 may form an exterior of the robot cleaner 1 and may accommodate various parts of the robot cleaner 1. The main body 10 may accommodate a brush for drawing in foreign substances on a surface to be cleaned, an intake motor for generating an intake force, a filter, a dustbin, a battery, and the like.

The driver unit 11 may include at least one wheel rotatable by a drive motor for traveling of the main body 10.

The electrophoretic display panel 20 may be attached to an upper surface of the main body 10. The electrophoretic display panel 20 may form a portion of an outer surface of the main body 10. The electrophoretic display panel 20 may display various designs or colors based on user input or operational status.

The electrophoretic display panel 20 may include a plurality of electrophoretic films 30 disposed adjacent to each other, an upper protective sheet 40 configured to cover an upper portion of the plurality of electrophoretic films 30, a lower protective sheet 50 configured to cover a lower portion of the plurality of electrophoretic films 30, and a sealing portion 60 configured to seal an outer periphery of the plurality of electrophoretic films 30, the upper protective sheet 40, and the lower protective sheet 50.

In the present embodiment, the electrophoretic display panel 20 illustrates a configuration in which three electrophoretic films 30 are disposed adjacent to each other to form an approximately circular shape in appearance, but is not limited thereto. Two or more plurality of electrophoretic films 30 may be arranged, and an overall shape formed by the adjacently disposed plurality of electrophoretic films 30 may be provided in various shapes, such as a circle, an ellipse, a rectangle, a polygon, and the like.

The plurality of electrophoretic films 30 may display various designs or colors based on user input. Alternatively, the plurality of electrophoretic films 30 may display various designs or colors based on an operational status of the robot cleaner 1.

Each of the plurality of electrophoretic films 30 may be configured to implement two colors. In addition, each electrophoretic film 30 may display a different color from its neighboring electrophoretic film 30. Thus, the electrophoretic display panel 20 may display more colors and designs by a plurality of neighboring electrophoretic films 300. This may provide the user with aesthetic beauty of the product and may produce various color changes according to various operational states of the robot cleaner 1.

The electrophoretic film 30 may include a pair of electrode layers 31 and 32 and an electrophoretic layer 33 disposed between the pair of electrode layers 31 and 32.

The pair of electrode layers 31 and 32 may be electrically connected to a power supply 12. The power supply 12 may provide different polarities to the pair of electrode layers 31 and 32.

The pair of electrode layers 31 and 32 may include a lower electrode layer 31 including a pixel electrode, and a transparent electrode layer 32 including a common electrode.

A plurality of gate lines and a plurality of data lines formed to intersect each other may be formed on the lower electrode layer 31 to form the pixel electrodes. In addition, the lower electrode layer 31 may include a thin film transistor (TFT). By switching of the TTF, a data voltage supplied through the data lines may be supplied to the pixel electrodes.

The lower electrode layer 31 may be formed of a material with high insulation properties. The lower electrode layer 31 may include a substrate provided with pixel electrodes. The pixel electrode may be formed of a material with high electrical conductivity. The pixel electrode may be formed in a single-layer structure of copper, aluminum, indium tin oxide (ITO), or indium zinc oxide (IZO), or in a multi-layer structure in which nickel or gold is laminated to a material of copper, aluminum, ITO, or IZO. The substrate may be formed from an inorganic material, such as an insulated metal film or an organic material, such as polyethylene terephthalate, but is not limited thereto. In an example, the substrate may be formed of various materials, such as glass or plastic.

The transparent electrode layer 32 may be formed of a material with high transparency and insulation properties. The transparent electrode layer 32 may include a transparent substrate with a common electrode. The common electrode may include a transparent conductive material, such as ITO or IZO. The transparent substrate may be a transparent polymer film with excellent light transmittance and may be of polyethersulfone (PES), polyacrylate (PAR), polyetherimide (PEI), polyethylene naphthalate (PEN), polyethylene terephthalate (PET), polyphenylene sulfide (PPS), polyallylate, polyimide, polycarbonate (PC), cellulose triacetate (TAC), or the like, but is not limited thereto.

Depending on the operation of the power supply 12, a potential difference may or may not be generated between the pair of electrode layers 31 and 32. The power supply 12 may be electrically connected to a processor 14 of the robot cleaner 1, which will be described later, and its operation may be controlled by the processor 14.

The electrophoretic layer 33 may be positioned between the transparent electrode layer 32 and the lower electrode layer 31. The electrophoretic layer 33 may display an image by moving charged particles by an electric field formed through the pixel electrodes.

According to an embodiment, the electrophoretic layer 33 may include a plurality of microcapsules 36 comprising a plurality of charged particles 34 and a solvent 35. The electrophoretic layer 33 disclosed may be shown as being consisting of a single-layer microcapsule array, but is not limited thereto.

According to an embodiment, the electrophoretic layer 33 may include a multi-layer microcapsule array or a single-layer microcup array. In addition, the microcapsules 36 provided in the electrophoretic layer 33 may be shown as spherical, but may have a non-spherical shape, a cuboidal, shape, or the like.

The charged particles 34 of the electrophoretic layer 33 may be black, white, or colored particles, and may include two types of charged particles charged with different polarities.

The electrophoretic film 30 described above is merely an embodiment, and the electrophoretic film 30 may not be limited as long as it is a device that displays an image using an electrophoretic phenomenon, in which the charged particles of the electrophoretic layer 33 located between the pair of electrode layers 31 and 32 are moved by an externally applied electric field.

The upper protective sheet 40 may be arranged to cover an upper portion of the plurality of neighboring electrophoretic films 30. The upper protective sheet 40 may be provided in a shape corresponding to a shape implemented by the plurality of neighboring electrophoretic films 30. The upper protective sheet 40 may be provided in a shape slightly larger than the shape formed by the plurality of neighboring electrophoretic films 30. The upper protective sheet 40 may comprise a single sheet that covers the entirety of the plurality of neighboring electrophoretic films 30.

The upper protective sheet 40 may be provided in a flat plate shape having a given thickness. An edge of the upper protective sheet 40 may be provided with a stepped surface 41 protruding outwardly from an edge of the plurality of electrophoretic films 30 bonded to the upper protective sheet 40.

The upper protective sheet 40 may be formed of a transparent glass material or a transparent plastic material. The upper protective sheet 40 may include any one of acrylic (poly methyl methacrylate, PMMA), polycarbonate (PC), and polyethylene terephthalate (PET).

The lower protective sheet 50 may be arranged to cover a lower portion of the plurality of neighboring electrophoretic films 30. The lower protective sheet 50 may be provided in a shape corresponding to a shape implemented by the plurality of neighboring electrophoretic films 30. The lower protective sheet 50 may include a single sheet that covers the entirety of the plurality of neighboring electrophoretic films 30.

The lower protective sheet 50 may be formed of the same material as the upper protective sheet 40. The lower protective sheet 50 may be formed of a different material from the upper protective sheet 40. The lower protective sheet 50 may be formed of a transparent, translucent, or opaque material.

The lower protective sheet 50 may include any one of acrylic (poly methyl methacrylate, PMMA), polycarbonate (PC), and polyethylene terephthalate (PET).

The sealing portion 60 may seal the outer periphery of the plurality of bonded electrophoretic films 30, the upper protective sheet 40, and the lower protective sheet 50. The sealing portion 60 may prevent infiltration of moisture, foreign substances, or the like into a gap between each layer by surrounding an outer circumference of the upper protective sheet 40, the lower protective sheet 50, and the plurality of neighboring electrophoretic films 30.

The sealing portion 60 may be formed by applying a sealing fluid near the stepped surface 41 using a dispenser. The sealing fluid may include a ultraviolet (UV) curable resin. The sealing fluid may include a UV curable urethane acrylate-based paint.

The sealing portion 60 may cover the entire rear side of the stepped surface 41. The sealing portion 60 may be configured to surround the stepped surface 41 of the upper protective sheet 40, the periphery of the plurality of neighboring electrophoretic films 30, and the sides of the lower protective sheet 50.

The sealing portion 60 may compensate for a step difference between the periphery of the plurality of neighboring electrophoretic films 30 and the periphery of the lower protective sheet 50.

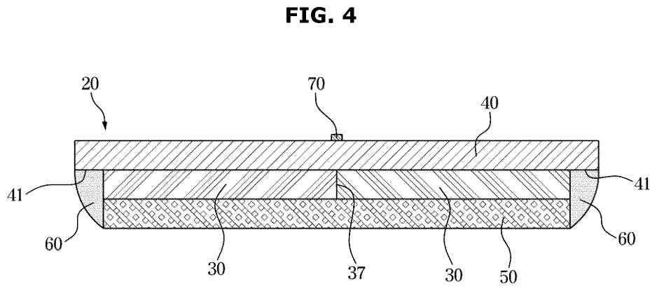

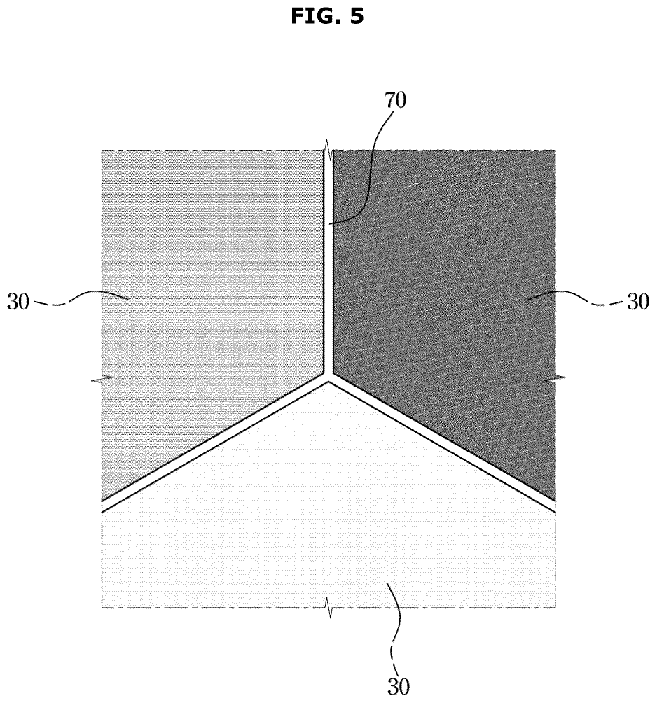

FIG. 4 schematically illustrates a cross-section of the electrophoretic display panel according to an embodiment of the present disclosure, and FIG. 5 is a plan view of the electrophoretic display panel of FIG. 4. In the following, the same reference numerals are given to the same configurations, and detailed descriptions thereof will be omitted.

Referring to FIGS. 4 and 5, a printed portion 70 may be provided on a surface of the upper protective sheet 40. The printed portion 70 may be formed on an upper surface of the upper protective sheet 40. The printed portion 70 may be configured to cover a boundary (or boundary surface) 37 between the plurality of neighboring electrophoretic films 30. The printed portion 70 may prevent the boundary 37 formed by the plurality of neighboring electrophoretic films 30 from being exposed to an outside. The printed portion 70 may be printed in a pattern corresponding to the boundary 37 formed between each of the plurality of neighboring electrophoretic films 30. Here, the boundary 37 may be defined as a contact surface where the plurality of neighboring electrophoretic films 30 are in contact, or a gap formed between the plurality of electrophoretic films 30.

The printed portion 70 may be formed using any one of screen printing, dispense, squeezing, and inkjet printing methods.

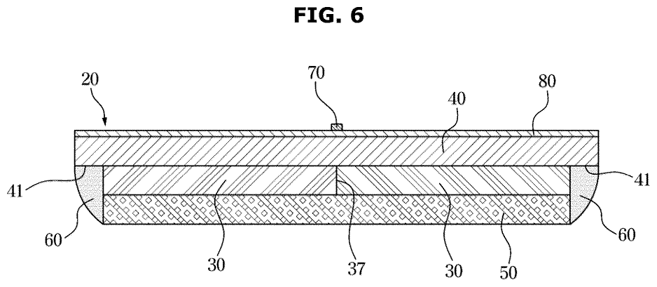

FIG. 6 schematically illustrates a cross-section of the electrophoretic display panel according to an embodiment of the present disclosure.

Referring to FIG. 6, when the upper protective sheet 40 is formed of a plastic material, a hard coating layer 80 may be provided on a surface of the upper protective sheet 40. The hard coating layer 80 may be provided with a transparent material.

The hard coating layer 80 may improve surface hardness, antifouling, and printability by being disposed on the upper surface of the upper protective sheet 40. The hard coating layer 80 may prevent the upper protective sheet 40 from being scratched.

When the hard coating layer 80 is provided on the upper protective sheet 40, the printed portion 70 may be formed on the hard coating layer 80.

The hard coating layer 80 may include a thermoplastic resin, a thermosetting resin, a UV curable resin, or the like. The hard coating layer 80 may be preferably formed of a UV curable resin that is cured by UV light irradiation to increase surface hardness and thereby exhibit high hard coating properties. In addition, the hard coating layer 80 may include an antifouling agent that is excellent for preventing fingerprints, stains, and scratches, or may include a surfactant that is favorable for printing.

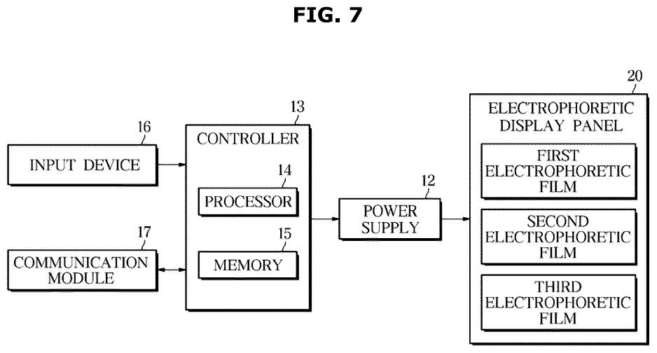

FIG. 7 is a block diagram illustrating some configurations of a robot cleaner, which is a type of home appliance, according to an embodiment of the present disclosure. While the block diagram disclosed illustrates a robot cleaner as an example, it may be a partial configuration of a home appliance, such as a refrigerator, dishwasher, air conditioner, as described above.

Referring to FIG. 7, the robot cleaner 1 may include an input device (e.g., an inputter) 16. The input device 16 may receive user input. The input device 16 may include a plurality of input buttons. Different input buttons of the input device 16 may acquire different user inputs. For example, the input device 16 may receive a command from a user for a type of color mode. Specifically, the input device 16 may receive a design change command or a color change command from the user. In addition, the input device 16 may receive an input for an operation mode of the robot cleaner 1.

The input device 16 may receive user input and output an electrical signal (voltage or current) corresponding to the user input to the processor 14. The processor 14 may receive user the input based on an output signal of the input device 16.

The input device 16 may include various types of input devices, such as a tact switch, a push switch, a slide switch, a toggle switch, a micro switch, a touch switch, or the like.

The robot cleaner 1 may include a communication module 17 that performs communication with an external electronic device. In an example, the communication module 17 may include a wireless communication module for performing communication with an external electronic device.

The communication module 17 may perform communication with an external electronic device to receive a command for a type of color mode input by a user from the external electronic device. In other words, the communication module 17 may perform communication with an external electronic device to receive a design change command or a color change command that the external electronic device has received from the user.

The external electronic device that performs communication with the communication module 17 may include, for example, an external user terminal device (e.g., smartphone, etc.). In addition, the communication module 17 may perform communication with an external server.

In an example, the communication module 17 may be configured as a transceiver that transmits signals to an external electronic device and receives signals from the external electronic device.

The robot cleaner 1 may include the power supply 12 configured to provide power to drive the electrophoretic display panel 20. The power supply 12 may apply power to the electrophoretic display panel 20.

More specifically, the power supply 12 may be electrically connected to each of the plurality of electrophoretic films 30 constituting the electrophoretic display panel 20, and may be configured to apply, or not apply, a potential difference between electrode layers of each of the plurality of electrophoretic films 30 based on electrical signals received from a processor 14.

The robot cleaner 1 may include a controller 13 for controlling various configurations of the robot cleaner 1.

The controller 13 may include the processor 14 that generates a control signal related to an operation of the robot cleaner 1, and a memory 15 that stores programs, applications, instructions, and/or data for the operation of the robot cleaner 1. The processor 14 and the memory 15 may be implemented as separate semiconductor devices or as a single semiconductor device.

Furthermore, the controller 13 may include a plurality of processors or a plurality of memories. The controller 13 may be provided at various locations inside the robot cleaner 1. For example, the controller 13 may be included on a printed circuit board provided in an electrical components portion (not shown) of the robot cleaner 1.

The processor 14 may include an arithmetic circuit, a storage circuit, and a control circuit. The processor 14 may include a single chip or a plurality of chips. In addition, the processor 14 may include a single core or a plurality of cores.

The processor 14 may be electrically connected to the memory 15. The processor 14 may be electrically connected to the input device 16. The processor 14 may be electrically connected to the communication module 17. The processor 14 may be electrically connected to the power supply 12 and the plurality of electrophoretic display panels 20.

The processor 14 may process data and/or signals using programs provided from the memory 15, and may transmit control signals to each configuration of the robot cleaner 1 based on a processing result. In an example, the processor 14 may process a signal received for a color mode and control the electrophoretic display panel 20 based on the signal. More specifically, the processor 14 may process user input received through the input device 16 of the robot cleaner 1 or user input received through the communication module 17 after being input by an external electronic device. The processor 14 may output control signals for controlling each configuration of the robot cleaner 1, such as the electrophoretic display panel 20 and/or the power supply 12, based on the electrical signals corresponding to the received color modes.

Each configuration of the robot cleaner 1, such as the electrophoretic display panel 20 and/or the power supply 12, may be operated based on the control signals of the processor 14.

The memory 15 may store various programs and data required for control, and may temporarily store temporary data generated during control.

The memory 52 may include a volatile memory, such as a static random access memory (S-RAM) or a dynamic random access memory (D-RAM), and a non-volatile memory, such as a read only memory (ROM), and an erasable programmable read only memory (EPROM). The memory 15 may include a single memory element or a plurality of memory elements.

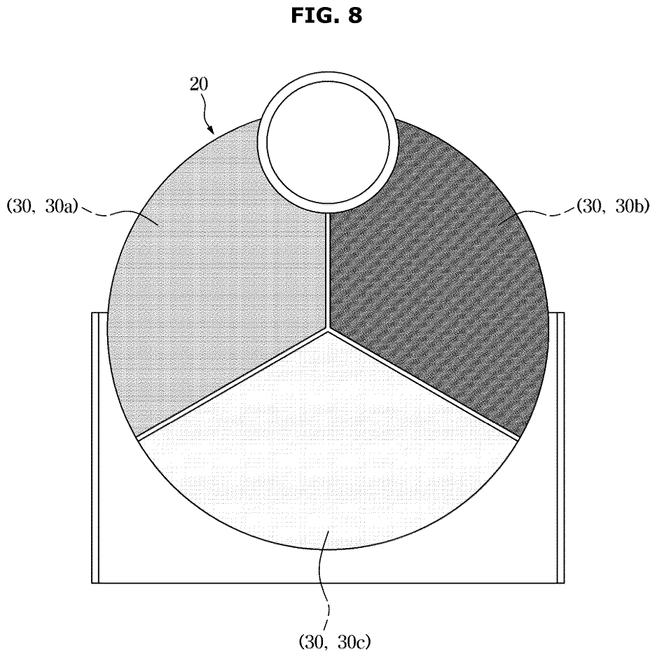

FIG. 8 illustrates a color change of the electrophoretic display panel of the robot cleaner, which is a type of home appliance, according to an embodiment of the present disclosure.

Referring to FIG. 8, the electrophoretic display panel 20 may implement various design patterns or color patterns by changing the respective colors of a first electrophoretic film 30a, a second electrophoretic film 30b, and a third electrophoretic film 30c, which are disposed adjacent to each other.

The electrophoretic display panel 20 may form a circular shape as a whole by having three pieces of electrophoretic films 30a, 30b and 30c disposed adjacent to each other, and may implement six color transformations as a whole by alternately displaying two colors on each piece.

Each of the electrophoretic films 30a, 30b and 30c may display a first color or a second color by a control signal from the processor 14. In other words, based on each of the electrophoretic films 30a, 30b and 30c being configured to display the first color or the second color, the electrophoretic display panel 20 may implement six design patterns by displaying the same or different colors of adjacent electrophoretic films 30a, 30b and 30c. As such, different design patterns may be presented to the user according to different modes of operation of the robot cleaner 1.

According to an embodiment, each of the electrophoretic films 30a, 30b and 30c may be configured to display two different colors. In an example, the first electrophoretic film 30a may display two colors, which are a first color and a second color, the second electrophoretic film 30b may display two colors, which are a third color and a fourth color, and the third electrophoretic film 30c may display two colors, which are a fifth color and a sixth color. Accordingly, the robot cleaner 1 may realize more colorful colors and various design patterns.

Although the embodiment of the present disclosure illustrates a configuration in which the electrophoretic display panel 20 has an electrophoretic film 30 divided into 3 pieces, the electrophoretic display panel 20 may be formed in various shapes, such as a circle, an ellipse, a polygon, and the like by more than two pieces of electrophoretic films 30 as a whole, as desired.

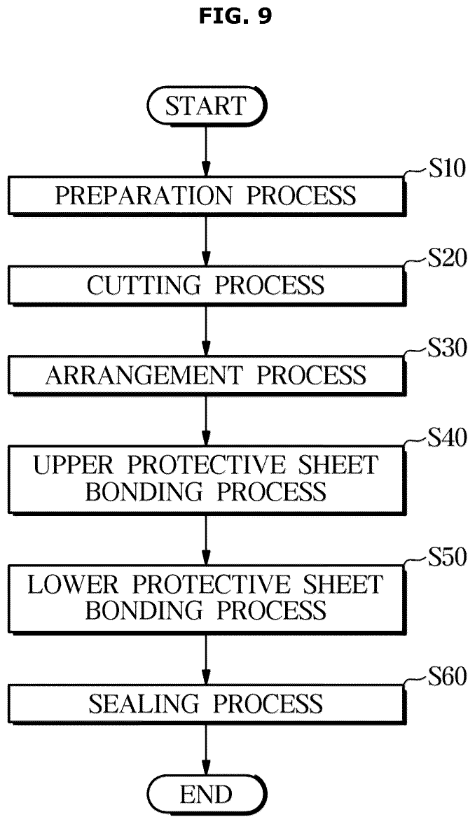

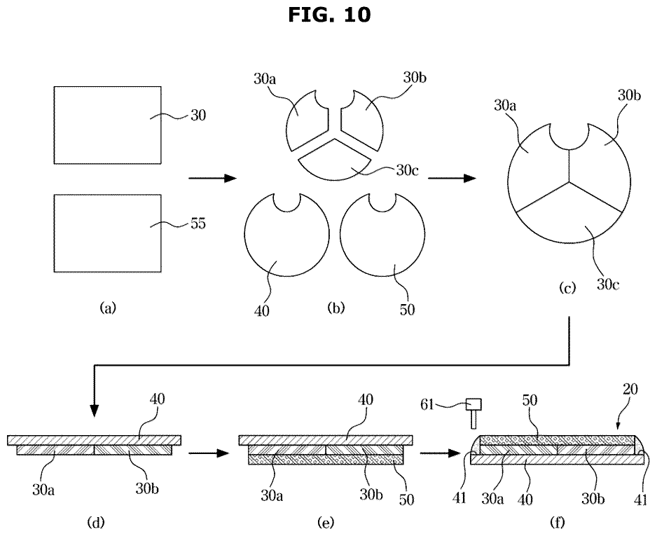

FIG. 9 is a flowchart illustrating a method of manufacturing an electrophoretic display panel according to an embodiment of the present disclosure, and FIG. 10 is a process diagram illustrating a method of manufacturing the electrophoretic display panel according to an embodiment of the present disclosure.

Referring to FIGS. 9 and 10, a method of manufacturing the electrophoretic display panel 20 may include a preparation process S10, a cutting process S20, an arrangement process S30, an upper protective sheet bonding process S40, a lower protective sheet bonding process S50, and a sealing process S60.

The preparation process S10 may be a process of preparing raw materials.

In the preparation process S10, as shown in FIG. 10(a), the raw materials may include the electrophoretic film 30 and a protective sheet 55. The electrophoretic film 30 may include a film-type product including the pair of electrode layers 31 and 32 and the electrophoretic layer 33. The protective sheet 55 may be prepared from sheets of the same material or different materials.

The cutting process S20 may be a process of cutting the electrophoretic film 30 and the protective sheet 55 into sizes according to the shape of a designed design.

In the cutting process S20, as shown in FIG. 10(b), the electrophoretic film 30 may be cut into the plurality of pieces 30a, 30b and 30c constituting the designed design shape, and the protective sheet 55 may be cut into a single sheet of a designed design shape and/or a shape that may cover the plurality of electrophoretic films 30. The cutting process S20 may be performed using a sheet cutting machine or a roll cutting machine.

In the cutting process S20, the protective sheet 55 of the same material may be cut to be manufactured into the upper protective sheet 40 and the lower protective sheet 50 of the same material, or the protective sheets 55 of different materials may be cut respectively to be manufactured into the upper protective sheet 40 and the lower protective sheet 50 of different materials.

The arrangement process S30, as shown in FIG. 10(C), may be a process of arranging the electrophoretic films 30a, 30b and 30c cut into a plurality of pieces adjacent to each other to form a designed design shape.

The upper protective sheet bonding process S40 may be a process of bonding the cut upper protective sheet 40 on an upper portion of the plurality of electrophoretic films 30.

In the upper protective sheet bonding process S40, as shown in FIG. 10(d), the upper protective sheet 40 may be attached on the upper portion of the plurality of neighboring electrophoretic films 30a, 30b and 30c using an adhesive, an adhesive sheet, thermal bonding, or a lamination process.

The lower protective sheet bonding process S50 may be a process of bonding the cut lower protective sheet 50 on a lower portion of the plurality of electrophoretic films 30a, 30b and 30c in a state in which the upper protective sheet 40 and the plurality of electrophoretic films 30a, 30b and 30c are bonded, as shown in FIG. 10(e).

The plurality of electrophoretic films 30a, 30b and 30c and the lower protective sheet 50 may be bonded using an adhesive, an adhesive sheet, thermal bonding, or a lamination process.

The sealing process S60 may be a process of sealing the outer periphery of the upper protective sheet 40, the plurality of electrophoretic films 30a, 30b and 30c, and the lower protective sheet 50, which are bonded to each other, by spraying and applying a sealing fluid.

In the sealing process S60, as shown in FIG. 10(f), the sealing portion 60 sealing the outer periphery of the electrophoretic display panel 20 may be formed by applying a sealing fluid to the stepped surface 41 of the upper protective sheet 40 using a dispenser 61.

The sealing fluid may include a material that is cured by ultraviolet light, such as a UV curable urethane acrylate paint, and the sealing portion 60 may be formed by irradiating the sprayed sealing fluid with ultraviolet light to cure the sealing fluid.

Meanwhile, in the embodiment illustrated in FIG. 9, the order of the upper protective sheet bonding process S40 and the lower protective sheet bonding process S50 may be reversed as needed. In other words, the lower protective sheet bonding process S50 may be performed first, followed by the upper protective sheet bonding process S40.

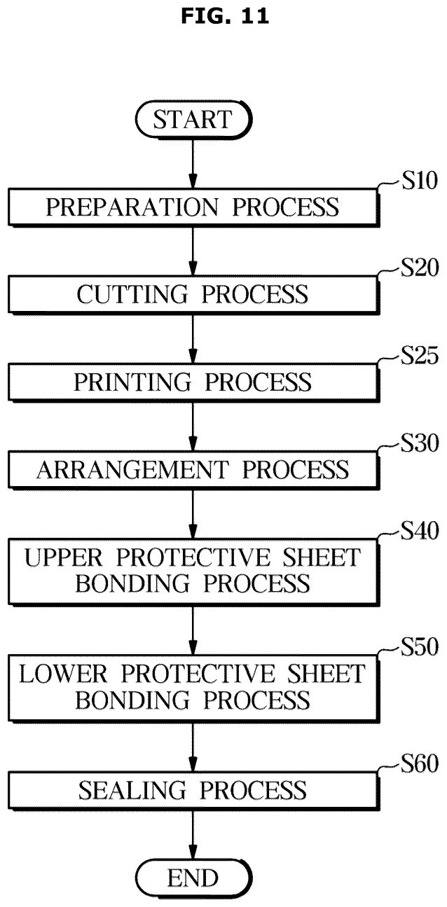

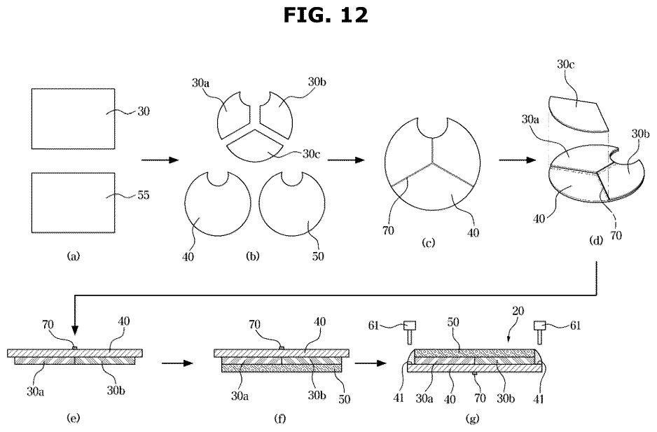

FIG. 11 is a flowchart illustrating a method of manufacturing an electrophoretic display panel according to an embodiment of the present disclosure, and FIG. 12 is a process diagram illustrating a method of manufacturing the electrophoretic display panel according to an embodiment of the present disclosure.

Referring to FIGS. 11 and 12, a method of manufacturing the electrophoretic display panel 20 may be the same as the manufacturing method described above, except that the manufacturing method further includes a printing process S25 prior to the arrangement process S30.

The method for manufacturing the electrophoretic display panel 20 may perform the printing process S25 after performing the preparation process S10 (see FIG. 12(a)) and the cutting process S20 (see FIG. 12(b)).

The printing process S25, as shown in FIG. 12(c), may be a process of forming the printed portion 70 at a position corresponding to the contact surface of the plurality of electrophoretic films 30a, 30b and 30c disposed adjacent to the surface of the upper protective sheet 40.

The printed portion 70 may be formed by coating the upper protective sheet 40 with a printing material using an inkjet printing method, a roll printing method, a reverse offset printing method, a thermal imaging method, a gravure offset method, a micro-contact printing method, a gravure roll printing method, or an imprinting method, and then curing the printing material using ultraviolet light or heat.

In the arrangement process S30, as shown in FIG. 12(d), the plurality of electrophoretic films 30a, 30b and 30c may be disposed on a rear surface of the upper protective sheet 40 on which the printed portion 70 is formed.

When the printed portion 70 is formed on the upper protective sheet 40, each of the electrophoretic films 30a, 30b and 30c may be easily disposed in an area partitioned by the printed portion 70. This may improve productivity by reducing the reject rate caused by misalignment of the plurality of electrophoretic films 30a, 30b and 30c.

Thereafter, the electrophoretic display panel 20 may be completed by performing the upper protective sheet bonding process S40 (see FIG. 12(e)), the lower protective sheet bonding process S50 (see FIG. 12(f)), and the sealing process S60 (see FIG. 12(g)).

Meanwhile, in the embodiment illustrated in FIG. 11, the order of the upper protective sheet bonding process S40 and the lower protective sheet bonding process S50 may be reversed as needed. In other words, the lower protective sheet bonding process S50 may be performed first, followed by the upper protective sheet bonding process S40.

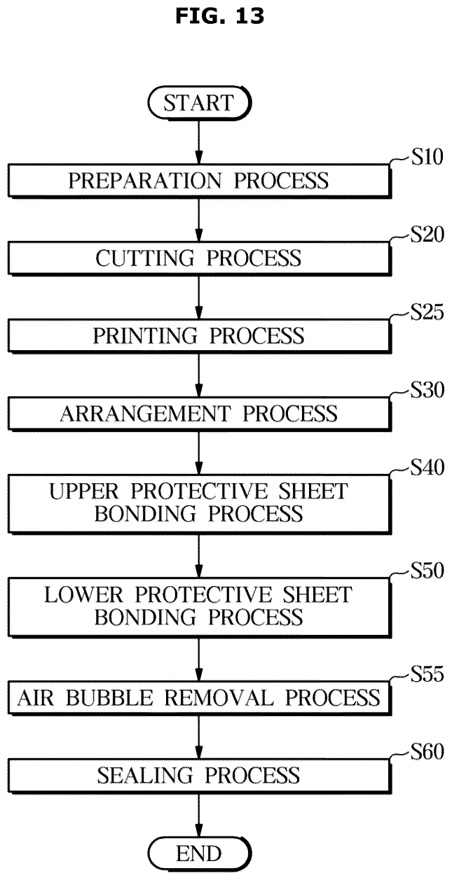

FIG. 13 is a flowchart illustrating a method of manufacturing an electrophoretic display panel according to an embodiment of the present disclosure.

Referring to FIG. 13, a method of manufacturing the electrophoretic display panel 20 may further include an air bubble removal process S55 prior to the sealing process S60.

The air bubble removal process S55 may be a process of removing residual air bubbles between each layer after the upper protective sheet 40, the plurality of electrophoretic films 30, and the lower protective sheet 50 are bonded together.

In the air bubble removal process S55, air bubbles existing between each layer may be moved to the outside by applying heat and pressure to the bonded material (i.e., bonded laminate) using an autoclave device.

By performing the sealing process S60 after completely removing air bubbles present in the bonded material through the air bubble removal process S55, the defect rate of the electrophoretic display panel 20 may be significantly reduced.

Meanwhile, in the embodiment disclosed in FIG. 13, the printing process S25 before an arrangement process S30 may be omitted if necessary.

In addition, the order of the upper protective sheet bonding process S40 and the lower protective sheet bonding process S50 may be reversed as needed. In other words, the lower protective sheet bonding process S50 may be performed first, followed by the upper protective sheet bonding process S40.

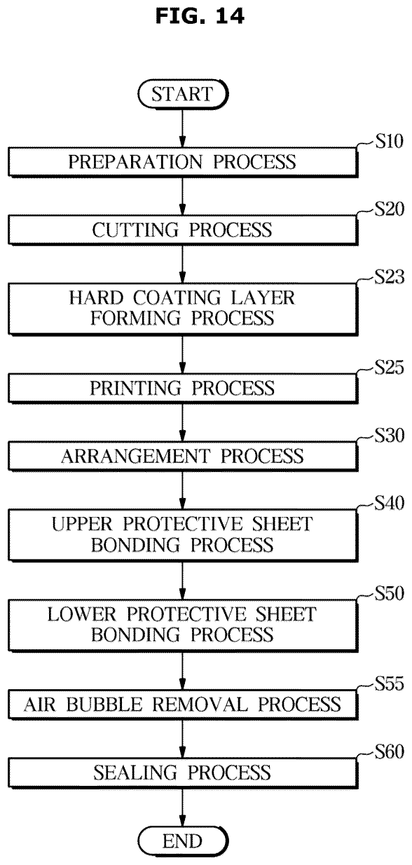

FIG. 14 is a flowchart illustrating a method of manufacturing an electrophoretic display panel according to an embodiment of the present disclosure.

Referring to FIG. 14, a method of manufacturing the electrophoretic display panel 20 may further include a hard coating layer forming process S23 prior to the printing process S25.

The hard coating layer forming process S23 may be a process of forming a hard coating layer 80 on the surface of the cut upper protective sheet 40.

The hard coating layer 80 may be formed by applying a coating liquid such as a thermoplastic resin, a thermosetting resin, or a UV curable resin to the entire surface of the upper protective sheet 40.

The hard coating layer forming process S23 may use an inkjet printing method, a roll printing method, a reverse offset printing method, a thermal imaging method, a gravure offset method, a micro-contact printing method, a gravure roll printing method, or an imprinting method.

The hard coating layer forming process S23 may be performed to prevent scratches when the upper protective sheet 40 is of a plastic material.

Thereafter, in the printing process S25, the printed portion 70 may be formed on the hard coating layer 80 coated on the upper protective sheet 40.

Meanwhile, in the embodiment illustrated in FIG. 14, the printing process S25 may be omitted as needed after the hard coating layer forming process S23. In this case, the arrangement process S30, the upper protective sheet bonding process S40, the lower protective sheet bonding process S50, the air bubble removal process S55, and the sealing process S60 may be performed after the hard coating layer forming process S23.

In addition, the air bubble removal process S55 may be omitted as needed, and then the sealing process S60 may be performed.

In addition, the order of the upper protective sheet bonding process S40 and the lower protective sheet bonding process S50 may be reversed as needed. In other words, the lower protective sheet bonding process S50 may be performed first, followed by the upper protective sheet bonding process S40.

An electrophoretic display panel according to an embodiment may include the plurality of electrophoretic films 30 disposed adjacent to each other, the upper protective sheet 40 arranged to cover an upper portion of the plurality of electrophoretic films, the lower protective sheet 50 arranged to cover a lower portion of the plurality of electrophoretic films, and the sealing portion 60 configured to seal an outer periphery of the plurality of electrophoretic films 30, the upper protective sheet 40, and the lower protective sheet 50. According to the present disclosure, the electrophoretic display panel may implement various colors and design patterns by the plurality of electrophoretic films 30 disposed adjacent to each other.

The electrophoretic display panel 20 may further include the printed portion 70 printed on the upper protective sheet to cover the boundary 37 between the plurality of electrophoretic films 30 disposed adjacent to each other, thereby improving exterior quality.

Each of the plurality of electrophoretic films 30 may include the pair of electrode layers 31 and 32 and the electrophoretic layer 33 disposed between the pair of electrode layers.

The upper protective sheet 40 may be a single sheet having a relatively larger shape than a shape formed by the plurality of electrophoretic films.

The upper protective sheet may include a plastic material, and a hard coating layer 80 may be provided on a surface of the upper protective sheet, thereby preventing damage, such as scratches.

The lower protective sheet 50 may include any one of a transparent, opaque, and translucent material.

A home appliance according to an embodiment may include the main body 10 and the electrophoretic display panel 20 configured to display operation and manipulation information of the main body, wherein the electrophoretic display panel includes the plurality of neighboring electrophoretic films 30, the upper protective sheet 40 arranged to cover an upper portion of the plurality of electrophoretic films, the lower protective sheet 50 arranged to cover a lower portion of the plurality of electrophoretic films, and the sealing portion 60 configured to seal an edge of the plurality of electrophoretic films, the upper protective sheet, and the lower protective sheet.

The home appliance may further include the printed portion 70 on the upper protective sheet to cover a gap between the plurality of electrophoretic films.

Each of the plurality of electrophoretic films may include the electrophoretic layer 33 disposed between the pair of electrode layers 31 and 32.

The upper protective sheet 40 may include a single sheet having a relatively larger shape than a shape formed by the plurality of electrophoretic films 30.

The home appliance may further include the processor 14 configured to drive the plurality of electrophoretic films, and the processor may control the plurality of electrophoretic films to display different colors based on operation and manipulation information of the main body.

A method of manufacturing an electrophoretic display panel according to an embodiment may include: preparing the electrophoretic film 30 and the protective sheet 55, cutting the electrophoretic film and the protective sheet 55, arranging the plurality of cut electrophoretic films 30a, 30b and 30c adjacent to each other, bonding the upper protective sheet 40 on an upper portion of the plurality of neighboring electrophoretic films, the upper protective sheet cut to a size capable of covering the plurality of electrophoretic films, and bonding the lower protective sheet 50 on a lower portion of the plurality of neighboring electrophoretic films, the lower protective sheet cut to a size capable of covering the plurality of electrophoretic films.

The method may further include sealing by applying a sealing fluid to an outer periphery of the plurality of electrophoretic films, the upper protective sheet, and the lower protective sheet, which are bonded together.

The method may further include removing air bubbles existing between each layer of the plurality of electrophoretic films, the upper protective sheet, and the lower protective sheet, which are bonded together, before sealing by applying the sealing fluid.

The method may further include forming the printed portion 70 on a surface of the upper protective sheet at a position corresponding to the boundary 37 of the plurality of neighboring electrophoretic films.

The method may further include forming the hard coating layer 80 on an upper surface of the upper protective sheet.

The method may include forming the printed portion 70 on a surface of the hard coating layer at a position corresponding to a boundary 37 of the plurality of electrophoretic films.

The upper protective sheet 40 and the lower protective sheet 50 may include the same type of material.

The upper protective sheet 40 and the lower protective sheet 50 may include different materials.

The upper protective sheet 40 may be a transparent material, and the lower protective sheet 50 may include any one of a transparent, opaque, and translucent material.

Although specific embodiments have been illustrated and described above, the present invention is not limited to the embodiments described above, and it will be apparent to those skilled in the art that various changes and modifications can be made without departing from the gist of the technical spirit of the invention described in the claims below.

1. An electrophoretic display panel comprising:
a plurality of electrophoretic films disposed adjacent to each other;
an upper protective sheet arranged to cover an upper portion of the plurality of electrophoretic films;
a lower protective sheet arranged to cover a lower portion of the plurality of electrophoretic films; and
a sealing portion configured to seal an outer periphery of the plurality of electrophoretic films, an outer periphery of the upper protective sheet, and an outer periphery of the lower protective sheet.

2. The electrophoretic display panel of claim 1, further comprising a printed portion on the upper protective sheet to cover a boundary between the plurality of electrophoretic films disposed adjacent to each other.

3. The electrophoretic display panel of claim 1, wherein
each of the plurality of electrophoretic films comprises a pair of electrode layers and an electrophoretic layer disposed between the pair of electrode layers.

4. The electrophoretic display panel of claim 1, wherein
the upper protective sheet comprises a single sheet having a relatively larger shape than a shape formed by the plurality of electrophoretic films.

5. The electrophoretic display panel of claim 1, wherein
the upper protective sheet comprises a plastic material, and
a hard coating layer is on a surface of the upper protective sheet.

6. The electrophoretic display panel of claim 1, wherein
the lower protective sheet comprises any one of a transparent, opaque, and translucent material.

7. A method of manufacturing an electrophoretic display panel, the method comprising:
preparing an electrophoretic film and a protective sheet;
cutting the electrophoretic film into plurality of electrophoretic films and cutting the protective sheet into an upper protective sheet and a lower protective sheet;
arranging the plurality of electrophoretic films to be adjacent to each other;
bonding the upper protective sheet on an upper portion of a plurality of neighboring electrophoretic films among the plurality of electrophoretic films, the upper protective sheet cut to a size to cover the plurality of electrophoretic films; and
bonding the lower protective sheet on a lower portion of the plurality of neighboring electrophoretic films, the lower protective sheet cut to a size to cover the plurality of electrophoretic films.

8. The method of claim 7, further comprising:
sealing by applying a sealing fluid to an outer periphery of the plurality of electrophoretic films, the upper protective sheet, and the lower protective sheet, which are bonded together.

9. The method of claim 8, further comprising:
removing air bubbles existing between each layer of the plurality of electrophoretic films, the upper protective sheet, and the lower protective sheet, which are bonded together, before sealing by applying the sealing fluid.

10. The method of claim 7, further comprising:
forming a printed portion on a surface of the upper protective sheet at a position corresponding to a boundary of the plurality of neighboring electrophoretic films.

11. The method of claim 7, further comprising:
forming a hard coating layer on an upper surface of the upper protective sheet.

12. The method of claim 11, further comprising:
forming a printed portion on a surface of the hard coating layer at a position corresponding to a boundary of the plurality of electrophoretic films.

13. The method of claim 7, wherein
the upper protective sheet and the lower protective sheet are of a type of material that is same.

14. The method of claim 7, wherein
the upper protective sheet and the lower protective sheet are of different materials.

15. The method of claim 7, wherein
the upper protective sheet is a transparent material, and the lower protective sheet is any one of a transparent, opaque, and translucent material.
